(19) United States
(12) Patent Application Publication
(10) Pub. No.: US 2006/0146809 A1
(43) Pub. Date: Jul. 6, 2006

(54) Method and apparatus for accessing for storage system

(76) Inventors: Ryosuke Tsurumi, Yokohama (JP); Tsunehiko Baba, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/317,001

(22) Filed: Dec. 27, 2005

(30) Foreign Application Priority Data
Dec. 28, 2004 (JP) 2004-381999

(51) Int. Cl. H04L 12/50

(52) U.S. Cl. 370/360

(57) ABSTRACT

Exclusive control is exercised on access to a storage apparatus in a cluster system conducting system changeover. If a system fault has occurred in an execution system, a heartbeat message to a stand-by system is interrupted. A cluster program in the stand-by system detects a fault in the execution system. The cluster program transmits a request to a path setting program in an FC-SW to change over a disk access path from the execution system. Upon receiving the request, the path setting program rewrites a path management table, intercepts the disk access path from the execution system, and transmits a result of the processing to the cluster program. Upon receiving the result, the cluster program starts a server program. The server program starts business processing from a check point at the time when the business processing is stopped due to occurrence of the fault in the execution system.

### INCORPORATION BY REFERENCE

The present application claims priority from Japanese application JP2004-381999 filed on Dec. 28, 2004, the content of which is hereby incorporated by reference into this application.

### BACKGROUND OF THE INVENTION

The present invention relates to a computer system technique having a fault tolerance by including an execution system and a stand-by system. Furthermore, the present invention relates to an access control technique in communication in a computer.

If a fault has occurred in a certain system in a cluster system including a plurality of systems and a shared disk apparatus, processing can be continued by conducting changeover (hot swapping) to another system in the stand-by state. In such a system changeover system, there is a fear that data will be destroyed when writing to the shared disk apparatus is conducted simultaneously from a plurality of systems. Therefore, exclusive control becomes necessary in access to the shared disk apparatus (hereafter referred to as disk access).

When exclusive control is exercised on access to a shared disk apparatus from a plurality of computers according to a conventional technique, a method of using a RESERVE command and a RELEASE command in the SCSI (Small Computer System Interface) or a method of exercising control as to whether make the logical volume active or inactive using an LVM (Logical Volume Manager) is used.

The RESERVE command in the SCSI is capable of reserving a logical unit and preventing a RESERVE request given by another initiator from being accepted until the reservation is released by the RELEASE command. Such a technique is disclosed in “SPC SCSI-3 Primary Commands,” pp. 88-94, 1997. 3. 28 (online), T10 (Technical Committee of the International Committee on Information Technology Standards), (retrieved on Dec. 27, 2004), Internet <URL: http://www.t10.org/ftp/t10/drafts/spc/spc-r11a.pdf>.

Furthermore, in the LVM, it is possible to prevent disk access from a system that is not in the active state by controlling the active state and the inactive state on the VG (Volume Group) with cluster software in the execution system and the stand-by system. Such a technique is disclosed in “How the Cluster Manager Works,” (online), Ninth Edition, June 2004, Hewlett-Packard Development Company, (retrieved on Dec. 27, 2004), Internet <URL: http://docs.hp.com/en/B3936-90073/ch03s02.html>.

On the other hand, as means for preventing illegal disk access from a specific computer, there is a method of retaining a table in the disk apparatus to store ports of a disk apparatus associated with identification information of higher rank apparatuses and rejecting access from previously defined higher rank apparatuses. Such a technique is disclosed in JP-A-10-333839.

When conducting system changeover in response to occurrence of a system fault in a cluster system having a shared disk apparatus, it is necessary to prevent the faulty system from conducting writing to the shared disk apparatus in order to prevent illegal double writing to the disk apparatus. As its method, means for resetting a faulty system (an execution system in which a system fault has occurred) from a stand-by system at timing of system changeover and stopping disk access by stopping an OS (Operating System) itself is used. Such a technique is disclosed in JP-A-10-207855.

### SUMMARY OF THE INVENTION

For preventing data destruction caused by double writing to the disk apparatus, exclusive control on disk access is necessary. If a fault has occurred in the system itself, however, the disk access cannot be controlled using the cluster software alone and consequently the system itself must be reset. In a system in which resetting is conducted, dedicated hardware having a reset mechanism is indispensable, resulting in a problem of the lack of flexibility. Furthermore, since the reset mechanism is needed, a cost is required also when adding a new computer to a system having a cluster configuration. Furthermore, for investigating a fault cause of a faulty system, processing of preserving the memory dump in the disk apparatus before resetting becomes necessary.

In view of the problem, an object of the present invention is to provide means for exercising exclusive control on access to a storage apparatus in a cluster system conducting system changeover.

In order to solve the problems, the present invention a storage access control method in a cluster system including a computer of execution system for conducting predetermined processing, a computer of stand-by system responsive to occurrence of a fault in the computer of execution system to take over processing conducted by the computer of execution system, a storage apparatus accessed by the computer of execution system and the computer of stand-by system in the processing to input and output predetermined data, and a path connection switch including a plurality of ports used respectively by the computer of execution system, the computer of stand-by system and the storage apparatus to conduct communication and controlling paths used to connect between those ports, the storage access control method including the steps of causing, in response to detection of occurrence of a fault in the computer of execution system, the computer of stand-by system to transmit a request to the path connection switch to change over paths between the computers and the storage apparatus, causing, in response to reception of the path changeover request, the path connection switch to set the paths so as to inhibit access between the computer of execution system and the storage apparatus and permit access between the computer of stand-by system and the storage apparatus and transmit a result of the path setting to the computer of stand-by system, and causing, in response to reception of the path setting result, the computer of stand-by system to take over the processing conducted by the computer of execution system. By the way, the present invention incorporates the cluster system, the path connection switch, and a storage access control program.

According to the present invention, exclusive control can be exercised on access to the storage apparatus in a cluster system conducting system changeover.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a functional configuration of a cluster system;

FIG. 2 is a flow chart showing system changeover processing;

FIG. 3 is a diagram showing a configuration of a path management table;

FIG. 4 is a diagram showing a hardware configuration of a cluster system;

FIG. 5 is a diagram showing a functional configuration of a cluster system according to a second embodiment;

FIG. 6 is a diagram showing a hardware configuration of a cluster system according to a second embodiment;

FIG. 7 is a flow chart showing system changeover processing according to a second embodiment;

FIG. 8 is a diagram showing a configuration of a zone management table according to a third embodiment;

FIG. 9 is a diagram showing a hardware configuration of a cluster system and an FC-SW according to a third embodiment;

FIG. 10 is a diagram showing a functional configuration of a cluster system according to a fifth embodiment; and

FIG. 11 is a diagram showing a configuration of a control table according to a fifth embodiment.

### DESCRIPTION OF THE EMBODIMENTS

Hereafter, embodiments of the present invention will be described in detail with reference to the drawings.

### 1. First Embodiment

<Configuration and Outline of System>

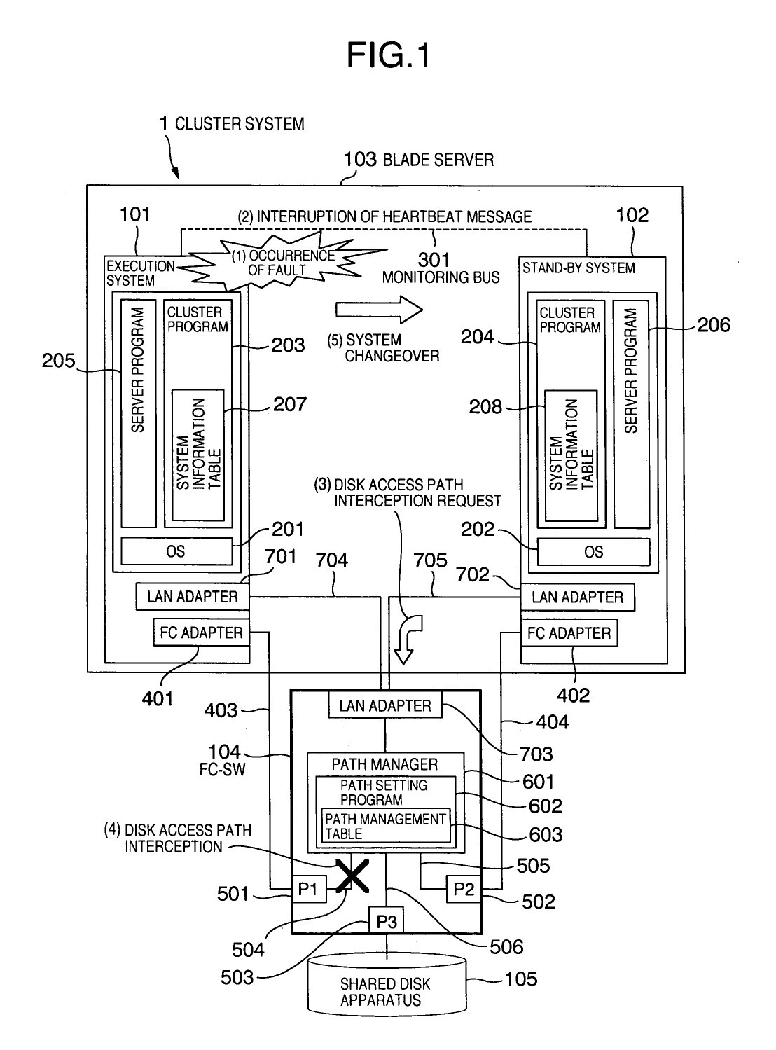

FIG. 1 is a diagram showing a functional configuration of a cluster system. A cluster system 1 includes a blade server 103, an FC-SW (Fiber Channel-Switch) 104, and a shared disk apparatus 105.

The blade server 103 includes an execution system 101 and a stand-by system 102. Here, the system corresponds to, for example, a blade (server board) incorporated in the blade server 103, and it corresponds to one computer capable of conducting predetermined business processing. Hereafter, the system is referred to as computer as well. The execution system 101 is a computer that is currently executing business processing (processing). The stand-by system 102 is a computer that does not currently conduct business processing and that takes over the business processing when a fault has occurred in the execution system 101. In other words, the stand-by system 102 is a computer that is waiting for the system changeover. OSs 201 and 202, cluster programs 203 and 204, and server programs 205 and 206 operate in computers respectively of the execution system 101 and the stand-by system 102, respectively. Each of the OSs 201 and 202 manages the whole system of a computer including a program that operates in the computer. Each of the cluster programs 203 and 204 monitors the system and conducts changeover. Each of the server programs 205 and 206 is an application program (also referred to as business program or program) that conducts business processing.

The cluster programs 203 and 204 respectively include system information tables 207 and 208 for retaining states of the own system and the other system. For example, an IP (Internet Protocol) address of each computer, a name of a server program operating on each computer, and kinds and names of shared resources are retained in each of the system information tables 207 and 208. The cluster program 203 conducts communication with the server program in its own system, and monitors the state of the server program 205.

Each of the cluster programs 203 and 204 operating on the computer checks whether the other system is normally operating by exchanging messages called heartbeat at fixed periods between the cluster programs 203 and 204. Transmission and reception of this heartbeat message are conducted by the cluster programs 203 and 204 via a monitoring path 301. If the cluster program 204 in the stand-by system 102 cannot detect the heartbeat message sent from the cluster program 203 in the execution system 101, then the cluster program 204 in the stand-by system 102 considers some fault to have occurred in the execution system 101 or on the monitoring path 301, and takes this as an opportunity for conducting the system changeover. By the way, the monitoring path 301 is implemented using a dedicated LAN (Local Area Network) or the like. Business process can be continued by conducting system changeover using the cluster program 204.

The computers include FC adapters 401 and 402, respectively. The computers can access the shared disk apparatus 105 respectively through buses 403 and 404, and the FC-SW 104.

The FC-SW 104 is connected to the execution system 101 and the stand-by system 102 in the blade server 103, and the shared disk apparatus 105. The FC-SW 104 manages and controls connection of a data transfer path between the respective systems and the shared disk apparatus 105. The FC-SW 104 includes a path manager 601. The path manager 601 manages data transfer buses 504, 505 and 506, which connect the path manager 601 to ports P1 501, P2 502 and P3 503. The FC-SW 104 further includes a path setting program 602 for exercising path control, and a path management table 603 for retaining whether path access is possible. A disk access request sent from the execution system 101 is received by the path manager 601 through the port P1 501. The path manager 601 refers to the path management table 603 by executing the path setting program 602, and determines whether the access is permitted. If the access is permitted, the access is conducted. If the access is not permitted, the request is rejected. LAN adapters 701 and 702 in the computers are connected to a LAN adapter 703 in the FC-SW 104 via paths 704 and 705, respectively. Thus, the LAN adapters 701 and 702 can conduct communication with the path manager 601 in the FC-SW 104. By the way, the paths 704 and 705 can be implemented using dedicated LANs or the like.

The shared disk apparatus 105 is accessed by the computers when the execution system 101 or the stand-by system 102 conducts business processing. Predetermined data is input to and output from the shared disk apparatus 105. The predetermined data is, for example, data or log information concerning business processing stored in a database.

Here, the example in which the storage apparatus (the shared disk apparatus 105) is accessed using the FC adapters 401 and 402 and the FC-SW 104 has been shown. Alternatively, the FC adapters 401 and 402 and the FC-SW 104 may be replaced respectively by the LAN adapters and the LAN switch, and an IP storage may be used as the storage apparatus. In FIG. 1, the control on the FC-SW 104 is conducted using the LAN including 701 to 705. Alternatively, the LAN may be replaced by a network using the FC.

Hereafter, outline of processing will be described. If a system fault has occurred in the execution system 101, the heartbeat message to the stand-by system 102 is interrupted. As a result, the cluster program 204 in the stand-by system 102 detects that a fault has occurred in the execution system 101. At that time, the cluster program 204 in the stand-by system 102 rewrites a state of the execution system 101 in the system information table 208 to change it from an operation state (a state in which the execution system 101 is conducting business processing as the execution system) to a fault state.

There is a possibility that the execution system 101 will be continuing access to the shared disk apparatus 105. Therefore, the cluster program 204 transmits a request (path changeover request) from the LAN adapter 702 to the path setting program 602 in the FC-SW 104 to disconnect the path 504 of disk access from the execution system 101. Thus, it becomes impossible for the execution system 101 to access the shared disk apparatus 105.

Upon receiving the request, the path setting program 602 retrieves the path that is being used by the execution system 101 from the path management table 603, and forcibly sets the path 504 to an access forbidden state. As a result, disk access from the execution system 101 is intercepted (forbidden). Thereafter, the path setting program 602 transmits a result of the processing (a result of path changeover) to the cluster program 204.

Upon receiving the result, the cluster program 204 takes over addresses of LAN adapters connected to an external network and starts the server program 206. If there are at least three systems, the cluster program 204 sends a changeover completion notice to all other systems. Upon being started by the cluster program 204, the server program 206 refers to data in the shared disk apparatus 105, and starts business processing from a check point at the time when the business processing is stopped due to occurrence of the fault in the execution system 101.

<Processing in System>

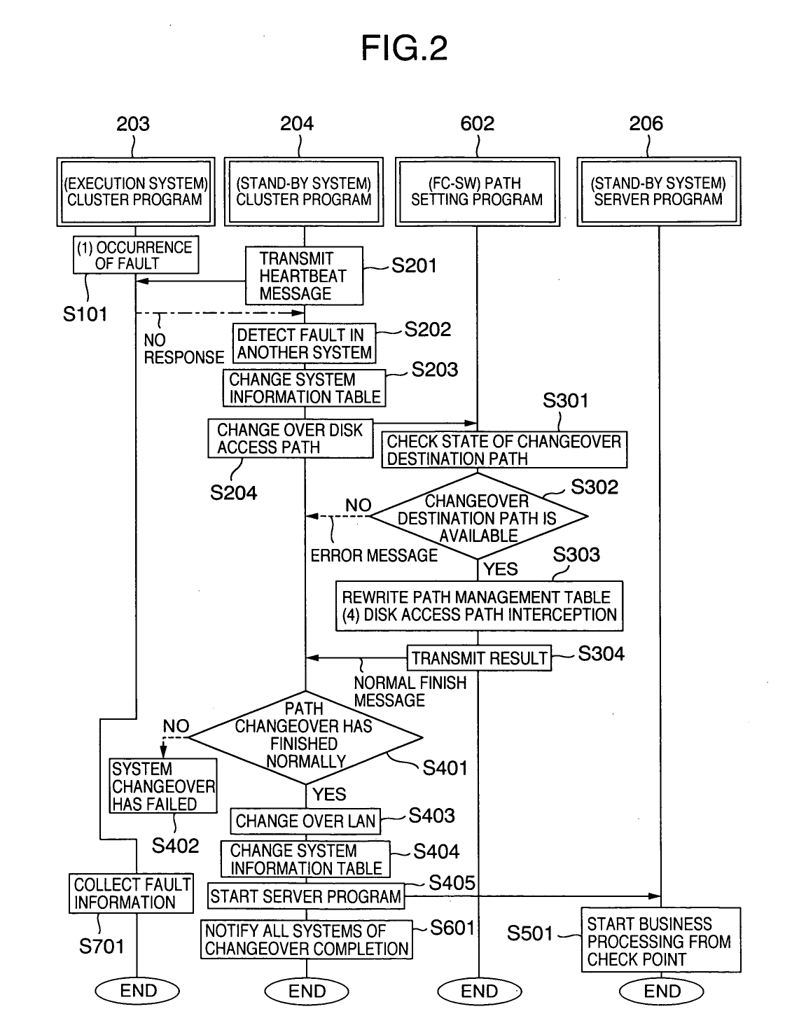

FIG. 2 is a flow chart showing system changeover processing. This series of processing includes processing of the cluster program 203 in the execution system 101, the cluster program 204 in the stand-by system 102, the path setting program 602 in the FC-SW 104, and the server program 206 in the stand-by system 102. This example shows a flow of processing conducted since occurrence of a fault in the execution system 101 until changeover to the stand-by system 102 resulting from detection of the fault conducted by the stand-by system 102. Herein, the fault is a fault detected on the basis of absence of a response to a heartbeat transmitted and received between the systems. The faults include hang-up or slowdown of the cluster program 203 in the execution system 101 which is conducting the business processing at that time and a communication fault of the monitoring bus 301.

If a fault occurs in the execution system 101 (S101), the cluster program 203 in the execution system 101 cannot return a response to a heartbeat message transmitted from the cluster program 204 in the stand-by system 102 at S201. When time over which the response is not returned from the cluster program 203 has exceeded a predetermined threshold, therefore, the cluster program 204 detects the fault (S202). Upon detecting the fault in the execution system 101, the cluster program 204 changes the state of the execution system 101 in the system information table retained therein (S203) from the operation state, and sets the state of the execution system 101 to the fault state. Thereafter, the cluster program 204 issues a disk access path changeover request to the path setting program 602 in the FC-SW 104 (S204). The disk access path changeover request includes a request for interception of the path 504 used for disk access and connection of a path from the stand-by system 102. The path setting program 602 checks whether the path 505 of the changeover destination to be used by the stand-by system 102 is available (S301). If the path 505 is available (yes at S302), the path setting program 602 intercepts (forbids) disk access conducted from the execution system 101, and rewrites the path management table 603 (details of which will be described later) to permit disk access from the stand-by system 102 (S303). Thereafter, the path setting program 602 transmits a result to the cluster program 204 (S304).

The cluster program 204 determines whether the path changeover has normally finished (S401). If the path changeover has not finished normally (no at S401), then it means that the system changeover has failed (S402) and subsequent system changeover processing is not conducted, and consequently the server program 206 is not started in the stand-by system 102. If the path changeover has finished normally (yes at S401), then the cluster program 204 in the stand-by system 102 conducts replacement of an alias IP address of a basic LAN adapter (LAN changeover) (S403), and conducts a state change in the system information table 208 (S404). Specifically, the cluster program 204 deletes the state of the execution system 101, and changes the state of the stand-by system 102 from the stand-by state to the operation state. This indicates that the stand-by system 102 has become a computer of the execution system. And the server program 206 is started (S405). The server program 206 in the stand-by system 102 refers to the shared disk apparatus 105, and starts business processing from a check point at the time when the business processing is stopped due to the occurrence of the fault in the execution system 101 (S501). If there are at least three systems, the cluster program 204 sends a changeover completion notice to all other systems (S601). By the way, the cluster program 203 in the execution system 101 can collect fault information after the disk access path 504 is disconnected (S701).

Owing to the series of processing heretofore described, it becomes possible to conduct the system changeover without conducting resetting by changing over the disk access path when a fault in the execution system 101 has been detected. It is possible to investigate the fault in the execution system 101 after the path changeover processing has been completed.

<Configuration of Table>

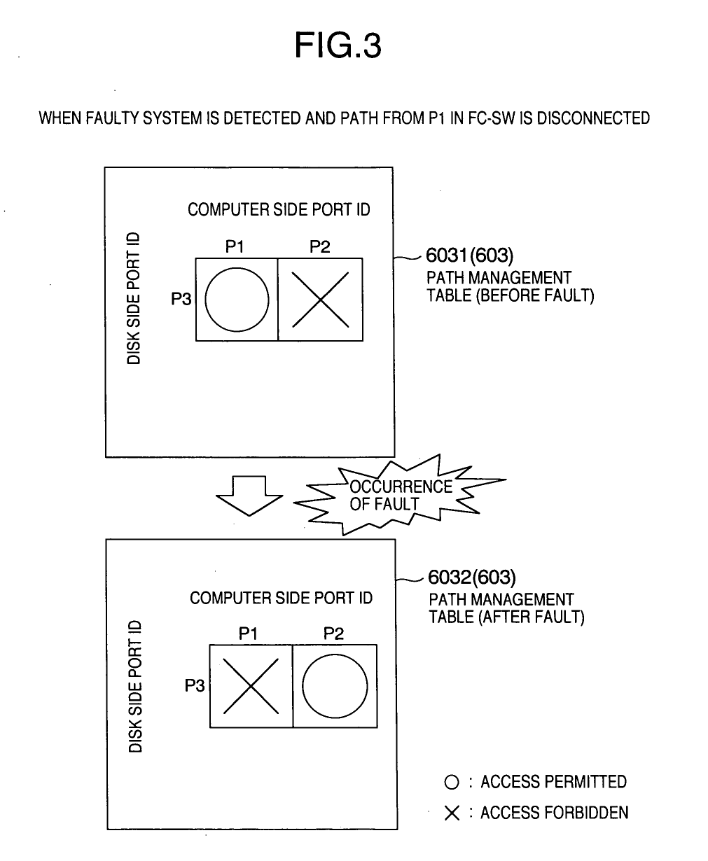

FIG. 3 is a diagram showing a configuration of a path management table together with states respectively preceding and subsequent to the occurrence of the fault. FIG. 3 shows the path management table 603 having a collection of information as to which inter-port path can be accessed in the FC-SW 104.

A path management table 6031 preceding the fault occurrence indicates that a disk (shared disk apparatus 105) side port IDP3 can be accessed from a computer side port IDP1, but the disk (shared disk apparatus 105) side port IDP3 cannot be accessed from a computer side port IDP2. If a system fault occurs in the execution system 101 and the stand-by system 102 issues a request to disconnect access to the port IDP3 from the port IDP1, then it becomes impossible to access the port IDP3 from the port IDP1, but it becomes possible to access the port IDP3 from the port IDP2 because of system changeover as shown in a path management table 6032 subsequent to the fault.

By providing the path management table 603 in the path manager 601 included in the FC-SW 104 and causing the path setting program 602 to exercise exclusive control on the shared disk apparatus 105, it is possible to certainly prevent writing into the shared disk apparatus from a system in which a fault has occurred (hereafter referred to as faulty system). Furthermore, since access paths between ports can be operated easily, flexible access control becomes possible even if the FC adapters are multiplexed.

<Configuration of Hardware>

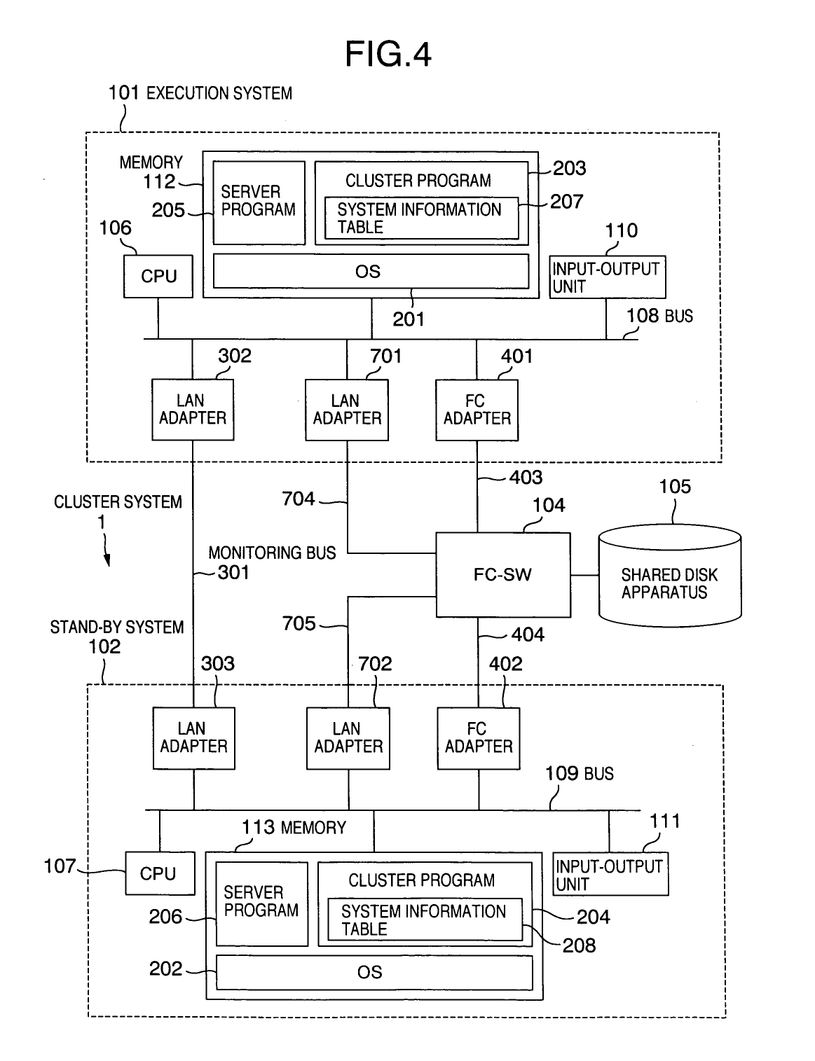

FIG. 4 is a diagram showing a hardware configuration of the cluster system. The cluster system 1 includes the execution system 101, the stand-by system 102, the FC-SW 104, and the shared disk apparatus 105. In the computer in the execution system 101, a CPU (Central Processing Unit) 106, a memory 112, a LAN adapter 302 for monitoring bus, the LAN adapter 701 for FC-SW control, the FC adapter 401 and an input-output unit 110 are connected via a bus 108. The computer in the stand-by system 102 has a similar configuration. The OSs 201 and 202, the cluster programs 203 and 204, and the server programs 205 and 206 are loaded onto the memory 112 and a memory 113, respectively. The cluster programs 203 and 204 include the system information tables 207 and 208 for managing information of the systems, respectively. The FC adapters 401 and 402, the LAN adapters 701 and 702, and the shared disk apparatus 105 are connected to the FC-SW 104. The LAN adapter 302 and a LAN adapter 303 for the monitoring bus are used to exchange the heartbeat messages to monitor the systems.

### 2. Second Embodiment

A second embodiment will now be described. Description that overlaps that of the first embodiment will be omitted.

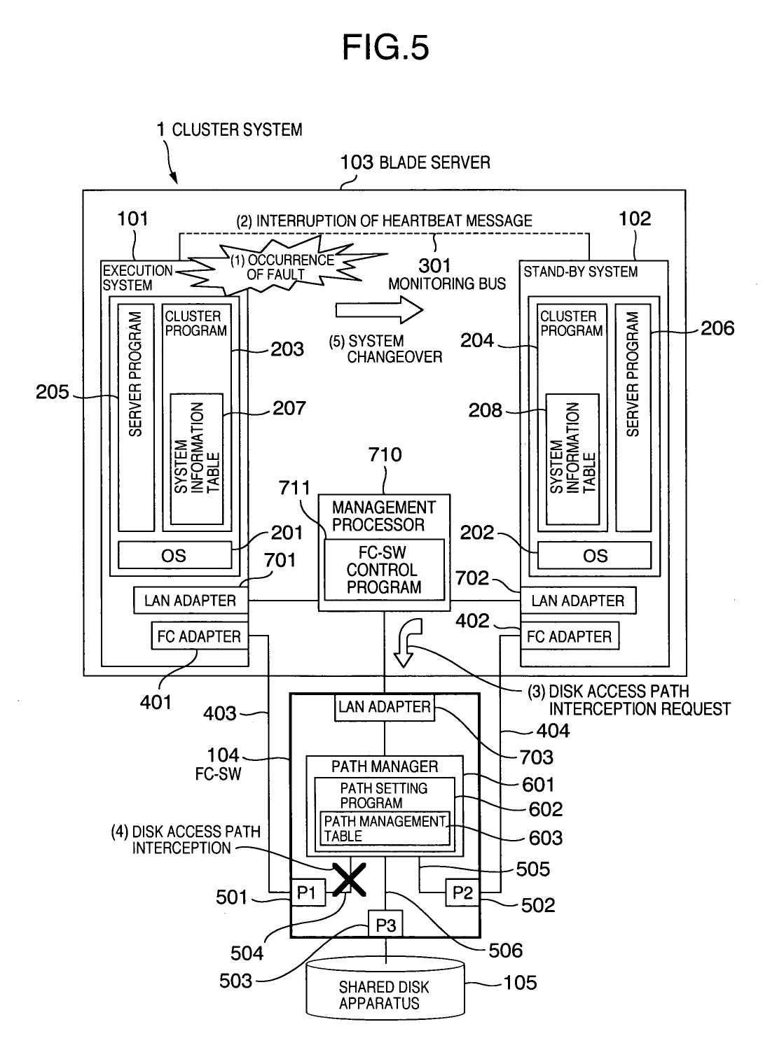

FIG. 5 is a diagram showing a functional configuration of a cluster system. Especially, FIG. 5 is a diagram showing the case where the management processor controls the FC-SW. In FIG. 1, the cluster program 204 controls the FC-SW 104. In a cluster system 1 in which a management processor 710 is incorporated in the blade server 103 as shown in FIG. 5, however, the management processor 710 controls the FC-SW 104. In FIG. 5, the LAN adapters 701 and 702 are connected to the management processor 710. The cluster program 204 issues a disconnection request for a disk access path from the faulty system 101 to the management processor 710. As a result, an FC-SW control program 711 operating in the management processor 710 issues a path disconnection request to the FC-SW 104, and the path setting program 602 in the FC-SW 104 disconnects the path 504.

Owing to the intervention of the management processor 710, the management processor 710 conducts protocol processing with the FC-SW 104. This results in an effect that the FC-SW 104 can be controlled without imposing load on the CPUs in respective systems.

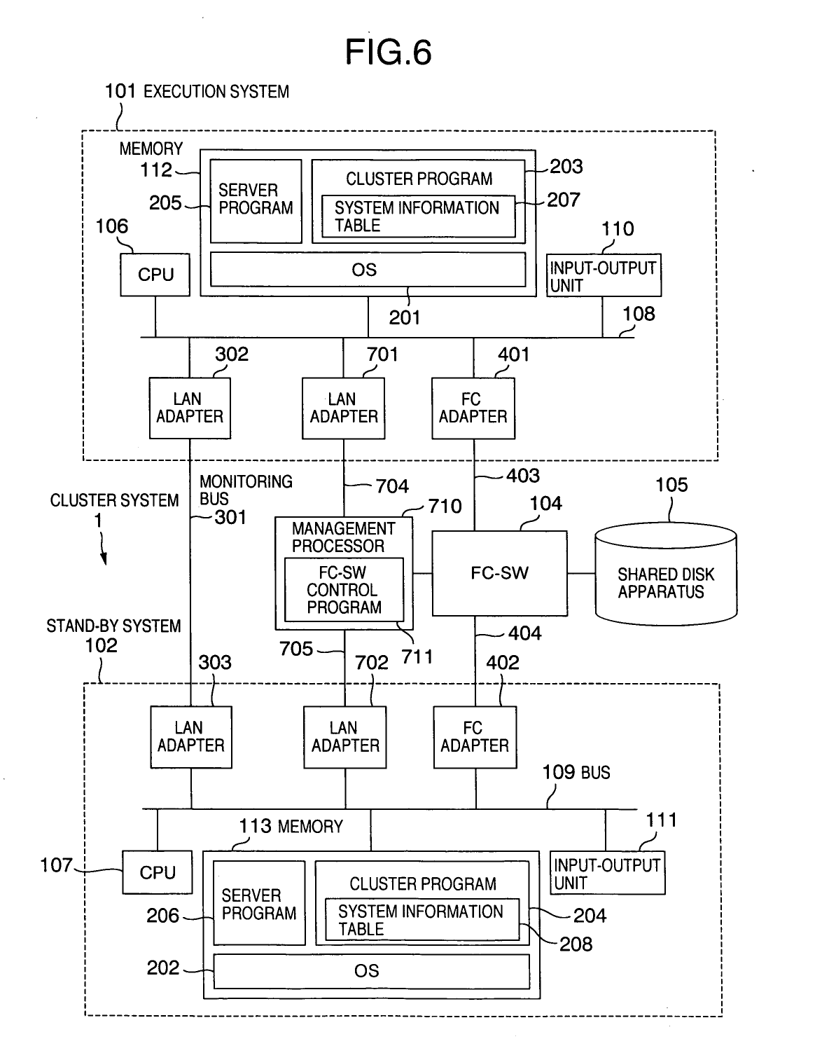

FIG. 6 is a diagram showing a hardware configuration of the cluster system. Especially, FIG. 6 is a diagram showing the case where the management processor controls the FC-SW. The LAN adapter 701 in the execution system 101 and the LAN adapter 702 in the stand-by system 102 are connected to the management processor 710. In the management processor 710, the FC-SW control program 711 is operating, and it is possible to control the FC-SW 104.

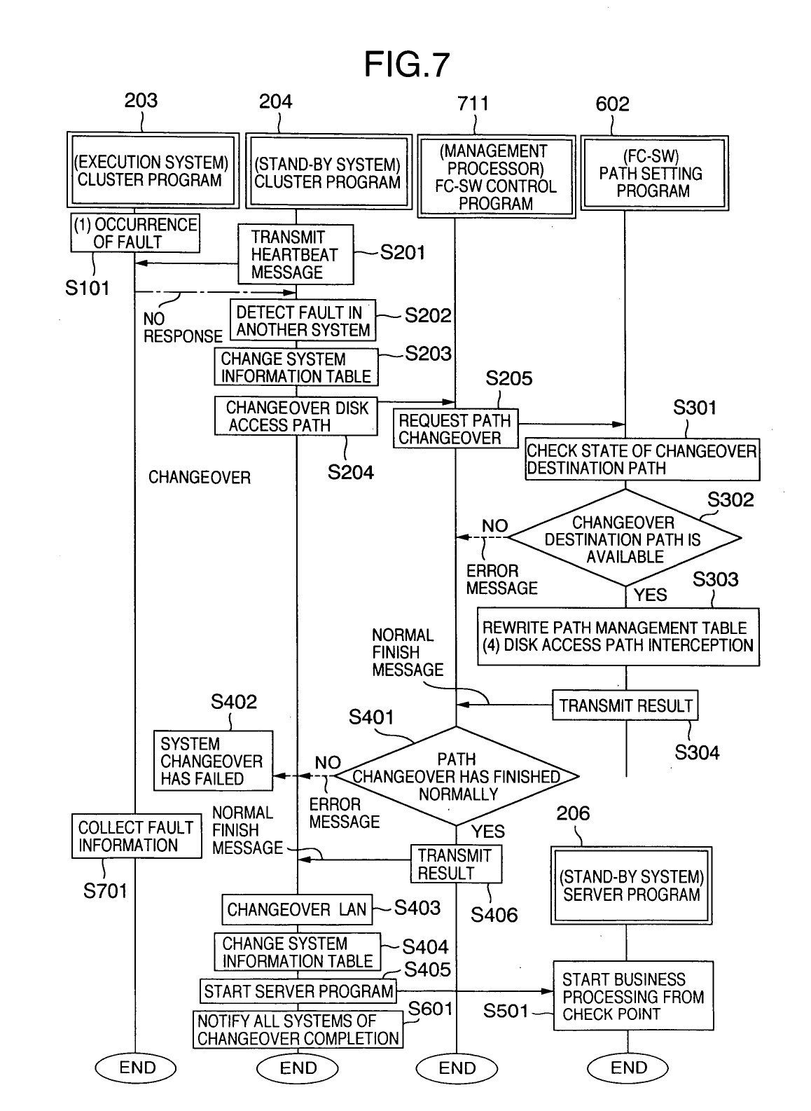

FIG. 7 is a flow chart showing system changeover processing. Especially, FIG. 7 is a diagram showing the case where the management processor controls the FC-SW.

A flow of processing (S101 to S204) conducted since occurrence of a fault in the execution system 101 until issue of a path changeover request from the cluster program 204 in the stand-by system 102 is the same as that shown in FIG. 2. If the management processor 710 receives a path changeover request from the cluster program 204, the FC-SW control program 711 issues a path changeover request to the FC-SW 104 (S205). The path setting program 602 in the FC-SW 104 investigates the state of the changeover destination path (S301). If the changeover destination path is available at this time (yes at S302), the path setting program 602 intercepts (forbids) disk access conducted from the execution system 101, and rewrites the path management table 603 to permit disk access from the stand-by system 102 (S303). And the path setting program 602 transmits a result to the FC-SW control program 711 (S304). The FC-SW control program 711 judges the result (S401). If the path changeover has not finished normally (no at S401), then the FC-SW control program 711 transmits an error message, which is a system changeover failure notice, to the cluster program 204 in the stand-by system 102, and the cluster program 204 suspends starting the server program 206. If the path changeover has finished normally (yes at S401), then the FC-SW control program 711 transmits the result to the cluster program 204 as a normal finish message (S406). Subsequent processing is the same as that shown in FIG. 2.

### 3. Third Embodiment

A third embodiment will now be described. Description that overlaps that of the above-described embodiments will be omitted.

In the case where a plurality of computers share the disk apparatus, it is possible in the FC-SW to define a port group in order to prevent illegal writing to the disk apparatus which is being used by another computer. Computers connected to ports belonging to different groups cannot recognize each other. This technique is called zoning. Illegal disk access can be prevented by using the zoning and separating the port of the faulty system to a different zone in response to occurrence of a system fault.

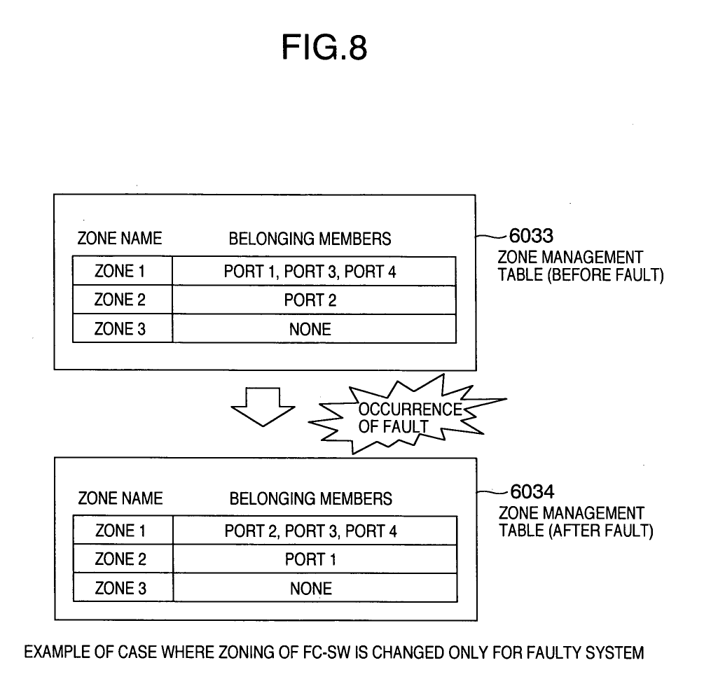

FIG. 8 is a diagram showing a configuration of a zone management table. The zone management table is a table provided for conducting exclusive access control between computers (the execution system (faulty system) 101 and the stand-by system 102) connected to ports and the shared disk apparatus 105 by changing ports belonging to zones. In a zone management table 6033 preceding occurrence of a fault, a port 1, a port 3 and a port 4 belonging to the FC-SW 104 are assigned to a zone 1, and a port 2 is assigned to a zone 2. As a result, control is exercised to prevent the stand-by system 102 connected to the port 2 from accessing the shared disk apparatus 105 connected to the port 3. If a fault occurs in the execution system 101 and system changeover is conducted, the port 1 is changed to the zone 2 and the port 2 is changed to the zone 1 as shown in a zone management table 6034 subsequent to the occurrence of the fault. Thereby, it is possible to forbid the faulty system 1 from accessing resources of the zone 1 (especially the shared disk apparatus 105) and permit the stand-by system 102 to access the resources of the zone 1 (especially the shared disk apparatus 105).

### 4. Fourth Embodiment

A fourth embodiment will now be described. Description that overlaps that of the above-described embodiments will be omitted.

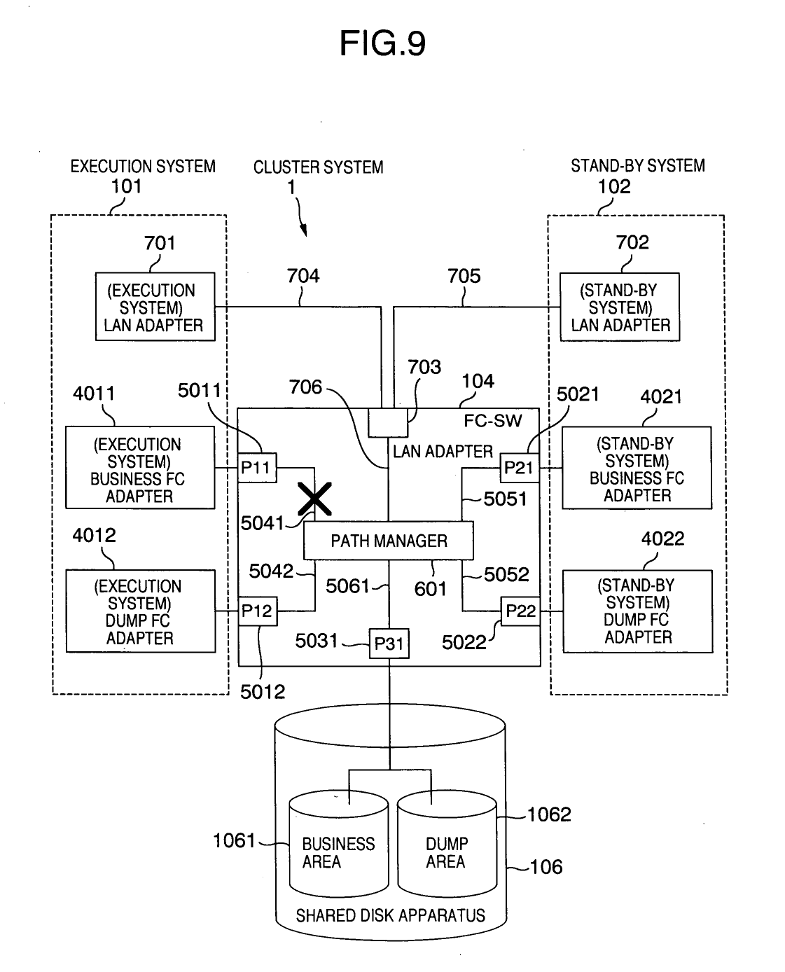

FIG. 9 is a diagram showing a hardware configuration of the cluster system and the FC-SW. Especially, FIG. 9 shows the case where the blade server does not have a local disk apparatus and an area for memory dump acquisition is present in the shared disk apparatus.

It is now supposed that memory dump to the shared disk apparatus is conducted in a cluster system including a blade server that does not have a local disk apparatus. If a data transfer bus of the faulty system is disconnected by system changeover, access to the shared disk apparatus becomes impossible and consequently memory dump of the faulty system cannot be acquired. The configuration shown in FIG. 9 solves this problem.

The configurations of the execution system 101 and the stand-by system 102 are the same as those shown in FIG. 1 except that two FC adapters are used. Therefore, the FC-SW 104, the shared disk apparatus, and portions connected to them are shown.

In this configuration, one FC is used for business and one FC is used for dump. In other words, business FC adapters 4011 and 4012 and dump FC adapters 4012 and 4022 are connected to the FC-SW 104 respectively via individual FC cables as shown in FIG. 9. A business area 1061 and a dump area 1062 and FC adapters (not illustrated) connected to those areas are included in the shared disk apparatus 106. By the way, the dump area 1062 is used to acquire the memory dump. As shown in FIG. 9, these adapters are connected to ports P11 (5011), P12 (5012), P21 (5021), P22 (5022) and P31 (5031) in the FC-SW 104. Paths between the ports are managed by the path manager 601. For each of the ports, the path manager 601 manages paths between the path and all other ports, and the path manager 601 can conduct connection (communication permitted) and disconnection (communication not permitted).

In FIG. 9, the business area 1061 and the dump area 1062 are shown to be provided in separate disk units in the shared disk apparatus 106. Alternatively, the business area 1061 and the dump area 1062 may be provided in separate logical units in one disk unit.

If a fault has occurred in the execution system 101, the cluster program 204 (see FIG. 1) in the stand-by system issues a request to the FC-SW 104 to disconnect a business path 5041 of the faulty system 101. Upon receiving the request, the FC-SW 104 disconnects the business path 5041 of the faulty system 101. However, the FC-SW 104 does not disconnect the dump path 5042. This means that access between the business FC (data transfer path) of the faulty system 101 and the shared disk apparatus 106 is inhibited and access between the dump FC (dump output path) and the shared disk apparatus 106 is permitted. Since the faulty system 101 can access the memory dump area 1062 even after the system changeover, therefore, the faulty system 101 can acquire the memory dump for the faulty system 101.

Even in the cluster system including the blade server that does not have a local disk apparatus, therefore, reset operation is unnecessary and it becomes possible to conduct the system changeover safely while acquiring the memory dump.

### 5. Fifth Embodiment

A fifth embodiment will now be described. Description that overlaps that of the above-described embodiments will be omitted.

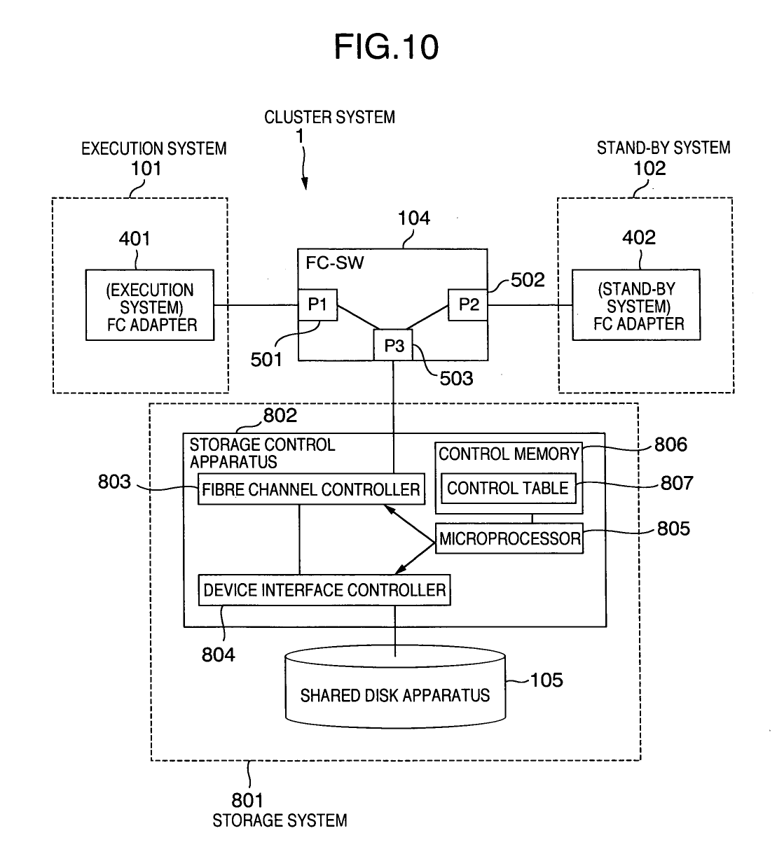

FIG. 10 is a diagram showing a functional configuration of the cluster system. Especially, FIG. 10 shows the case where exclusive control on disk access is exercised using a fiber channel connection storage and control apparatus (hereafter referred to as storage control apparatus).

Since configurations of the execution system and the stand-by system are the same as those shown in FIG. 1, the FC-SW 104 and a storage system 801 are shown. The FC-SW 104 is connected to the storage system 801, and the storage system 801 includes a storage control apparatus 802 and the shared disk apparatus 105. The storage control apparatus 802 includes a fibre channel controller 803, a device interface controller 804, a microprocessor 805, and a control memory 806. A control table 807 is stored in the control memory 806. Reading and writing can be conducted from the microprocessor 805. The fibre channel controller 803 conducts interrupt to the microprocessor 805 and response to a disk access request source in response to access from the execution system 101 and the stand-by system 102. The device interface controller 804 controls access to the shared disk apparatus 105.

If the storage controller 802 is used and a fault in the execution system 101 is detected, the cluster program 204 in the stand-by system 102 issues a request to the storage control apparatus 802 through the FC-SW 104 to reject disk access from the faulty system 101. The fibre channel controller 803 conducts interrupt to the microprocessor 805, and the microprocessor 805 rewrites the control table 807 so as to reject the request from the faulty system 101. If an access request is issued from the faulty system 101, access is set so as to be rejected when the microprocessor 805 refers to the control table 807. As a result, exclusive processing of the disk apparatus can be implemented, and it becomes possible to conduct the system changeover safely.

In this method as well, it is not necessary to reset the faulty system 101 and consequently it is not necessary to acquire the memory dump.

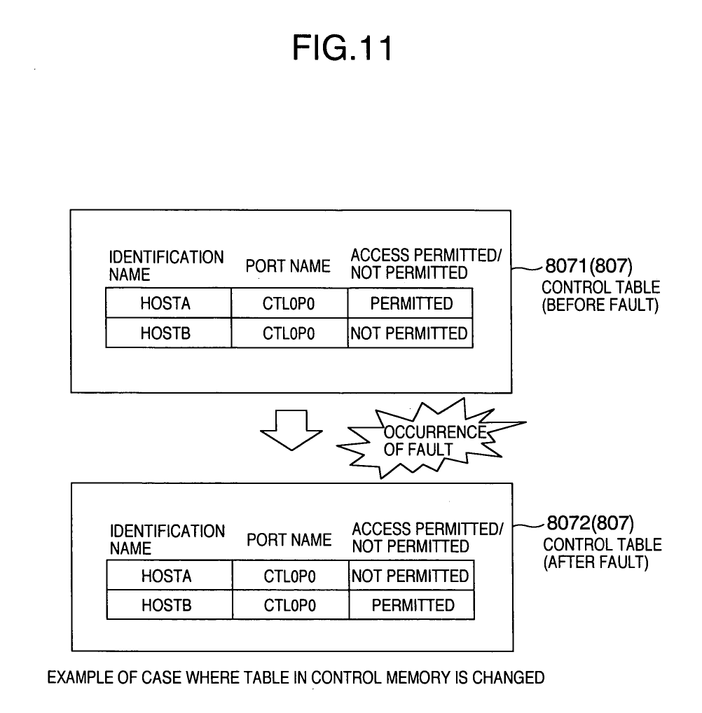

FIG. 11 is a diagram showing a configuration of a control table used in the storage control apparatus. An identification name used in the storage control apparatus 802 is HOSTA for the execution system 101, and it is HOSTB for the stand-by system 102. Furthermore, the fiber channel controller 803 is provided with CTL0P0 as a port name. Before a fault occurs, a control table 8071 is stored in the control memory 806. The execution system 101 can access the shared disk apparatus 105, whereas the stand-by system 102 cannot access the shared disk apparatus 105. If a fault has occurred in the execution system 101, the state is changed as shown in a control table 8072. The execution system 101 cannot access the shared disk apparatus 105, whereas the stand-by system 102 can access the shared disk apparatus 105.

According to the foregoing description, if the cluster program 204 in the stand-by system 102 has detected a fault in the execution system 101, system changeover can be conducted while preventing the faulty system 101 from illegally accessing the shared disk apparatus 105 by disconnecting the data transfer path 504 in the FC-SW 104. At that time, it is not necessary for the cluster program in the stand-by system 102 to conduct CPU reset processing for the execution system 101. Therefore, dedicated hardware required for reset processing becomes unnecessary. Therefore, the versatility is high and the cost is reduced. Accordingly, expansion of the computer also becomes easy.

Since the memory contents of the faulty system 101 are retained even after the changeover, it becomes possible to investigate the fault cause without acquiring the memory dump. Furthermore, software depending upon the OS such as the LVM also becomes unnecessary. In addition, increase of the throughput can also be anticipated using a multiplexed fiber cable for data transfer conducted between the faulty system 101 and the shared disk apparatus 105. As a result, exclusive control on access to the shared disk apparatus 105 from the computers in respective systems can be exercised certainly.

The embodiments have been described. The cluster system 1 according to the embodiments of the present invention is implemented by recording programs (including a storage access control program) executed in the cluster system shown in FIG. 1 on a computer readable recording medium, causing a computer system to read the programs recorded on the recording medium, and executing the programs.

### 6. Other Embodiments

The embodiments have been described. However, the present invention is not restricted to the embodiments, but changes can be made suitably without departing from the spirit of the present invention. For example, the following embodiments are conceivable.

(1) In the embodiments, two computers respectively in the execution system 101 and the stand-by system 102 are included in the blade server 103. However, the blade server 103 may include at least three computers. Furthermore, in the embodiments, one shared disk apparatus is used. However, two or more shared disk apparatuses may be used.

(2) In the embodiments, controls on the system changeover and disk access are exercised by the programs in the computers and the FC-SW. However, those controls may be exercised by hardware or object.

It should be further understood by those skilled in the art that although the foregoing description has been made on embodiments of the invention, the invention is not limited thereto and various changes and modifications may be made without departing from the spirit of the invention and the scope of the appended claims.

1. A storage access control method in a cluster system including:
an execution system computer for conducting predetermined processing;
a stand-by system computer responsive to occurrence of a fault in the execution system computer to take over processing conducted by the execution system computer;
a storage apparatus accessed by the execution system computer and the stand-by system computer in the processing to input and output predetermined data; and
a path connection switch including a plurality of ports used respectively by the execution system computer, the stand-by system computer and the storage apparatus to conduct communication, and controlling paths used to connect between those ports,
the storage access control method comprising:
the step that, in response to detection of occurrence of a fault in the execution system computer, the stand-by system computer transmits a request to the path connection switch to change over paths between the computers and the storage apparatus;
the step that, in response to reception of the path changeover request, the path connection switch sets the paths so as to inhibit access between the execution system computer and the storage apparatus and permit access between the stand-by system computer and the storage apparatus, and transmit a result of the path setting to the stand-by system computer; and
the step that, in response to reception of the path setting result, the stand-by system computer takes over the processing conducted by the execution system computer.

2. The storage access control method according to claim 1, wherein
the path connection switch comprises a fiber channel switch,
the path connection switch comprises a zone management table to manage relations between predetermined zones and ports belonging to the zones,
the path connection switch sets the zone management table so as to assign a port of the execution system computer and a port of the storage apparatus to different zones, when inhibiting access between the execution system computer and the storage apparatus, and
the path connection switch sets the zone management table so as to assign a port of the stand-by system computer and the port of the storage apparatus to the same zone, when permitting access between the stand-by system computer and the storage apparatus.

3. The storage access control method according to claim 1, wherein the path connection switch comprises a LAN switch.

4. The storage access control method according to claim 1, wherein
in the case where a memory dump area for the execution system computer and the stand-by system computer is included in the storage apparatus,
the cluster system comprises a data transfer path and a dump output path between the execution system computer and the path connection switch and between the stand-by system computer and the path connection switch as access paths, and
when inhibiting access between the execution system computer and the storage apparatus, the path connection switch inhibits access between the data transfer path of the execution system computer and the storage apparatus, and permits access between the dump output path of the execution system computer and the storage apparatus.

5. A storage access control method in a cluster system including:
an execution system computer for conducting predetermined processing;
a stand-by system computer responsive to occurrence of a fault in the execution system computer to take over processing conducted by the execution system computer;
a storage control apparatus accessed by the execution system computer and the stand-by system computer in the processing to control input and output of predetermined data;
a storage apparatus connected to the storage control apparatus to input and output the data; and
a path connection switch including a plurality of ports used respectively by the execution system computer, the stand-by system computer and the storage control apparatus to conduct communication, and connecting the execution system computer to the storage control apparatus and the stand-by system computer to the storage control apparatus,
the storage access control method comprising:
the step that, in response to detection of occurrence of a fault in the execution system computer, the stand-by system computer transmits a request to the storage control apparatus via the path connection switch to reject access from the execution system computer;
the step that, in response to reception of the request, the storage control apparatus sets an internal table so as to reject the access from the execution system computer; and
the step that the stand-by system computer takes over the processing conducted by the execution system computer.

6. A cluster system comprising:
an execution system computer for conducting predetermined processing;
a stand-by system computer responsive to occurrence of a fault in said execution system computer to take over processing conducted by said execution system computer;
a storage apparatus accessed by said execution system computer and said stand-by system computer in the processing to input and output predetermined data; and
a path connection switch including a plurality of ports used respectively by said execution system computer, said stand-by system computer and said storage apparatus to conduct communication, and controlling paths used to connect between those ports,
wherein
upon detecting occurrence of a fault in said execution system computer, said stand-by system computer transmits a request to said path connection switch to change over paths between the computers and said storage apparatus;
upon receiving the path changeover request, said path connection switch sets the paths so as to inhibit access between said execution system computer and said storage apparatus and permit access between said stand-by system computer and the storage apparatus, and transmits a result of the path setting to said stand-by system computer; and
upon receiving the path setting result, said stand-by system computer takes over the processing conducted by said execution system computer.

7. A path connection switch comprising a plurality of ports used respectively by:
an execution system computer for conducting predetermined processing;
a stand-by system computer responsive to occurrence of a fault in the execution system computer to take over processing conducted by the execution system computer; and
a storage apparatus accessed by the execution system computer and the stand-by system computer in the processing to input and output predetermined data,
paths used to connect between those ports being controlled by the path connection switch,
wherein in response to a request from the stand-by system computer, the path connection switch inhibits access between the execution system computer in which a fault has occurred and the storage apparatus, and permits access between the stand-by system computer and the storage apparatus.

8. A storage access control program for causing predetermined computers and path connection switch to execute the storage access control method according to claim 1.
